(19) United States
(12) Patent Application Publication
(10) Pub. No.: US 2018/0340133 A1
(43) Pub. Date: Nov. 29, 2018

(54) PLANT OIL EXTRACTION SYSTEM AND METHOD FOR PRODUCING ESSENTIAL OILS FROM PLANT MATERIAL

(71) Applicant: ROSIN TECHNOLOGIES, LLC, Irwindale, CA (US)

(72) Inventor: David Carbone, Monrovia, CA (US)

(21) Appl. No.: 15/987,862

(22) Filed: May 23, 2018

Related U.S. Application Data
(60) Provisional application No. 62/510,638, filed on May 24, 2017.

(51) Int. Cl. C11B 9/00; B01D 11/02

(52) U.S. Cl. CPC C11B 9/00; B01D 11/02

(57) ABSTRACT

An oil extraction unit is provided. The extraction unit applies temperature and pressure to a sample to increase the yield of high quality essential oils while avoiding undesirable material phase changes. The extraction unit applies heat and pressure to upper and lower heat platens that are placed above and below the sample. The upper and lower heat platens include embedded heating elements that are used to draw the extracted oils from the material. In use, the extracted oils are drawn away from the higher temperature heating elements and towards an area outside of the heat platens. A cooling plate may be applied outside of the heat platens to further draw out the extracted oils away from the heat platens and limit exposure of the oils to elevated temperatures.

### FIELD

The present disclosure relates to an extraction unit for extracting plant oils and to a process for extracting essential oils from plant material.

### BACKGROUND

Essential oils can be extracted from plant and other materials using mechanical separation via heat and pressure. However, existing methods are prone to over pressing the samples in order to process large batch sizes with sufficient oil yield. Such methods can lead to an undesirable phase change in the material, resulting in low quality oil.

### SUMMARY

Embodiments of the invention provide an extraction unit that applies temperature and pressure to a sample to increase the yield of high quality essential oils while avoiding undesirable material phase changes. In some embodiments, the extraction unit applies heat to upper and lower heat platens that are placed above and below the sample, and also applies pressure to the upper heat platens. The pressure and temperature can be electronically controlled to more precisely and accurately regulate temperature and pressure applied to a sample.

The extraction unit can include an automatically controlled pneumatic air cylinder for applying uniform or constant pressure to a sample. The upper and lower heat platens include embedded heating elements that are used to draw extracted oils from the material. The heating elements can apply a variable or oscillating temperature (or heat) profile to the sample. In use, the extracted oils are drawn away from the higher temperature heating elements and towards an area outside of the heat platens. A cooling plate may be applied outside of the heat platens to further draw out the extracted oils away from the heat platens and limit exposure of the oils to elevated temperatures. In addition, temperature sensors on the heat platens are used to monitor the applied temperature profile and provide feedback for automatically adjusting the heat applied to heating elements.

In some embodiments, the upper and lower heat platens contain a small surface area for processing small batch sizes of samples in the range of 2-6 or 6-14 grams. In further embodiments, the samples are pre-processed in a mold to create uniform samples of approximately even thickness. The samples may be placed in porous filter bags to allow extracted oils to be separated from the remaining plant material residue.

In some embodiments, the upper and/or lower heat platens are removable to enable quickly and easily changing the platens in between batches. This allows for using platens of different sizes for different batch runs, as well as simplified cleaning and maintenance.

### BRIEF DESCRIPTION OF THE DRAWINGS

FIG. 1 depicts a front isometric view of an oil extraction unit according to some embodiments of the invention;

FIG. 2 depicts a view from the right side of the oil extraction unit of FIG. 1;

FIG. 3 depicts a zoomed in view of FIG. 2;

FIG. 4 depicts a view of the extraction unit of FIG. 1;

FIG. 5 depicts a view from the left side of the oil extraction unit of FIG. 1;

FIGS. 6-8 depict views of a stage of the extraction unit of FIG. 1;

FIGS. 9A-9B depict views of an upper mount of the extraction unit of FIG. 1;

FIG. 10 depicts a view of a heat platen for use with the extraction unit of FIG. 1;

FIG. 11 illustrates a perspective view of an extraction unit according to some embodiments of the invention;

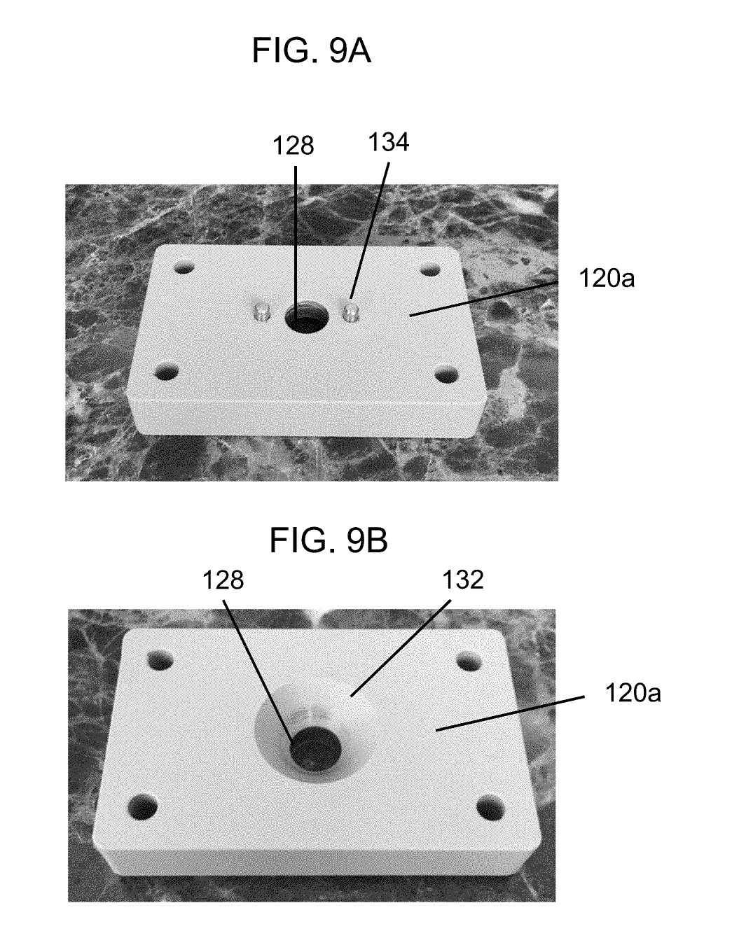

FIGS. 12A-12B illustrate cross-sectional views of the extraction unit of FIG. 11;

FIG. 13A illustrates a lower heat platen according to some embodiments;

FIG. 13B illustrates a cross-sectional view of FIG. 13A;

FIG. 14A illustrates an upper heat platen according to some embodiments;

FIG. 14B depicts an isolation mount according to some embodiments;

FIG. 15A illustrates an upper heat platen according to some embodiments;

FIG. 15B illustrates a cross-sectional view of FIG. 15A;

FIG. 16 illustrates a perspective view of an extraction unit according to some embodiments of the invention;

FIG. 17 illustrates a cross-sectional view of the extraction unit of FIG. 16;

FIGS. 18A-18C depict a sample preparation mold according to some embodiments of the invention; and

FIGS. 19A-19B depict a views of an upper mount according to some embodiments of the invention.

### DETAILED DESCRIPTION

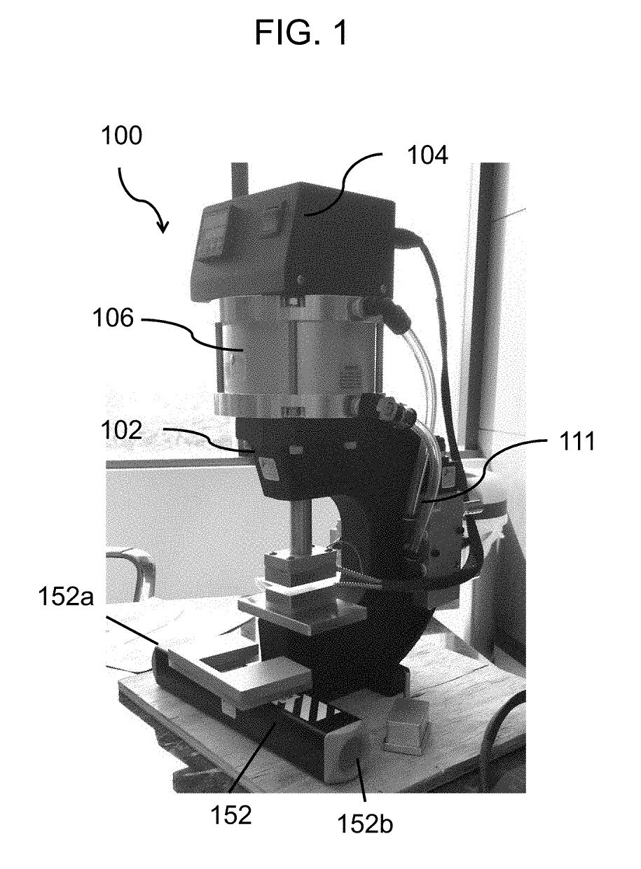

FIGS. 1-8 depict an oil extraction unit 100 according to some embodiments of the present disclosure. As described in more detail below, the oil extraction unit 100 uses pressure and heat to extract essential oils from a sample of material. During operation, heat is applied to a material sample using heating elements embedded in a stage, and pressure is also applied to the sample using an actuator. In various embodiments, the oil extraction process may use samples from a variety of materials, including flowers, vegetables, leaves, seeds, peels, berries, and bark, among other sources.

In some embodiments, oil extraction is aided by use of a constant, relatively exact pressure applied to a sample, as well as a variable or oscillating heat profile applied to the sample. The applied pressure uses mechanical forces to squeeze the sample to a desired (e.g., pre-determined) thickness. At or near the same time the pressure is applied (e.g., during the time when pressure is applied, or a short period after the pressure is applied), a temperature gradient or differential is used to extract oils from the sample, and also to help draw extracted oils away from the sample for collection. By selectively applying elevated temperatures to a sample, extracted oils are drawn away from the elevated temperature regions and towards the cooler regions. In some embodiments, for example, transient elevated temperatures can be applied towards middle regions of the sample with cooler regions towards the edges of the sample, which draws oils to the sample edges where they can be more easily collected. In some embodiments, active cooling at the edges of the sample can be applied (e.g., using cooling plates) to create larger temperature gradients. As described in more detail below, the oil extraction unit 100 is particularly adapted to use automatically controlled temperature and pressure for extracting oils.

In some embodiments, applying a set amount of pressure to the sample (i.e., wherein the amount of pressure applied does not vary or varies only within a narrow range over the course of the pressure application) can provide for increased effectiveness of the oil draw during heating. By applying pressure, the thickness of the sample is decreased, resulting in a lower porosity and greater surface contact within the sample relative to a non-pressed sample. Greater surface contact within the sample can allow for more effective heat transport via conduction than a more porous sample that has not be pressed (and that contains more air gaps that decrease thermal conduction). In some embodiments, the applied pressure may use maximum and minimum limits to avoid over-pressing and/or under-pressing a sample. An over-pressed sample may hinder the ability for oil to be drawn away from the sample for collection. For example, porosity within a sample can be used as a flow path for extracted oils to be drawn away from the sample and to preferred areas for collection. An over-pressed sample may lack sufficient flow paths for effectively removing extracted oils, thereby limiting the amount of extracted oils, or causing the oils to be exposed to elevated temperatures for an extended period of time leading to decreased oil quality. An under-pressed sample may have too much porosity, therefore decreasing the effectiveness of the applied heat and the amount of oil that can be extracted. As described above and as will be appreciated, the use of too much pressure or not enough pressure may result in less than sufficient yield of extractable oil from the sample or may cause extracted oil to become degraded (i.e., with a lower quality).

The oil extraction unit 100 of FIGS. 1-8 includes a frame 102, a temperature controller 104, an actuator 106, one or more air regulators 108, a stage 110, and a control valve 111.

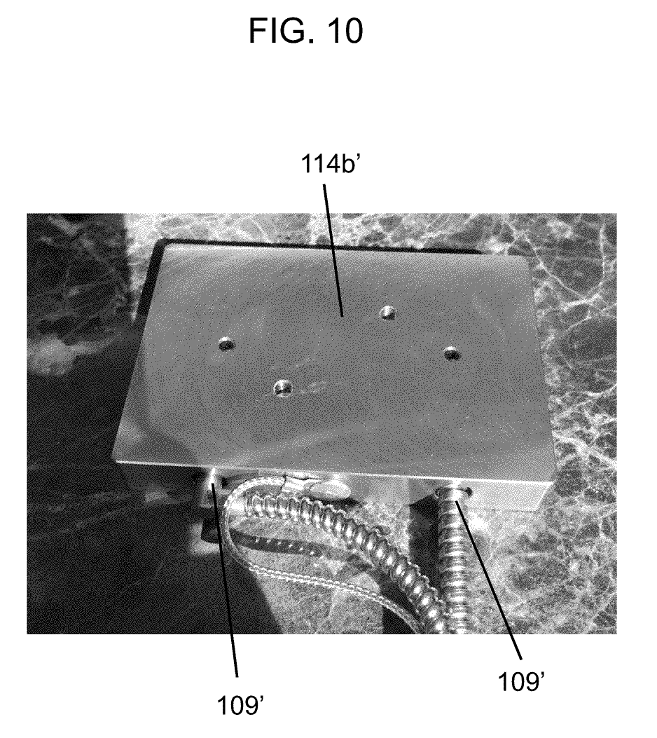

The frame 102 provides structural support for the components of the oil extraction unit 100. The frame 102 is designed to resist bending forces caused by the pressure of the actuator 106 during operation, and also to resist the effects of thermal expansion during heating of a sample on the stage 110, thereby allowing the device to produce a consistent and high quality product. In some embodiments, the frame 102 has a structure configured to maintain its shape even under repeated application and removal of pressure and temperature against the structure, and is made of a material with a high strength and stiffness (i.e., a material with a high Young's modulus). The material of the frame 102 also may have a low coefficient of thermal expansion to resist against changes in length due to changes in temperature (e.g., from either heating or cooling). In some embodiments, the frame 102 is made of iron, steel, stainless steel, a combination thereof, and the like. The frame 102 may have a substantially “C” shape when viewed from left or right sides of the oil extraction unit 100 (see FIGS. 1 and 12A) and may be a single integral unit that is located both above and below a sample to be pressed.

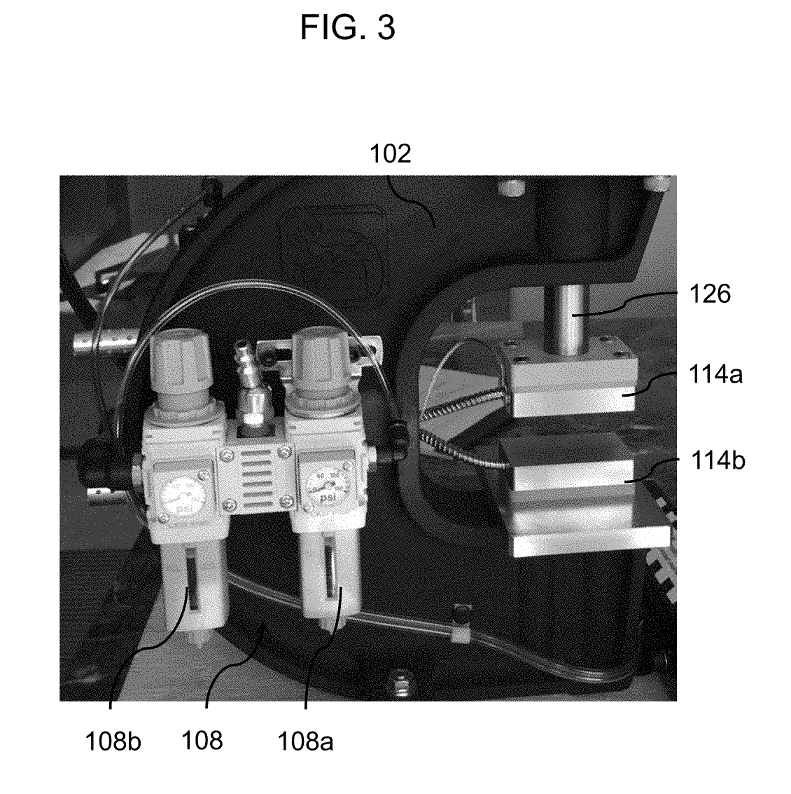

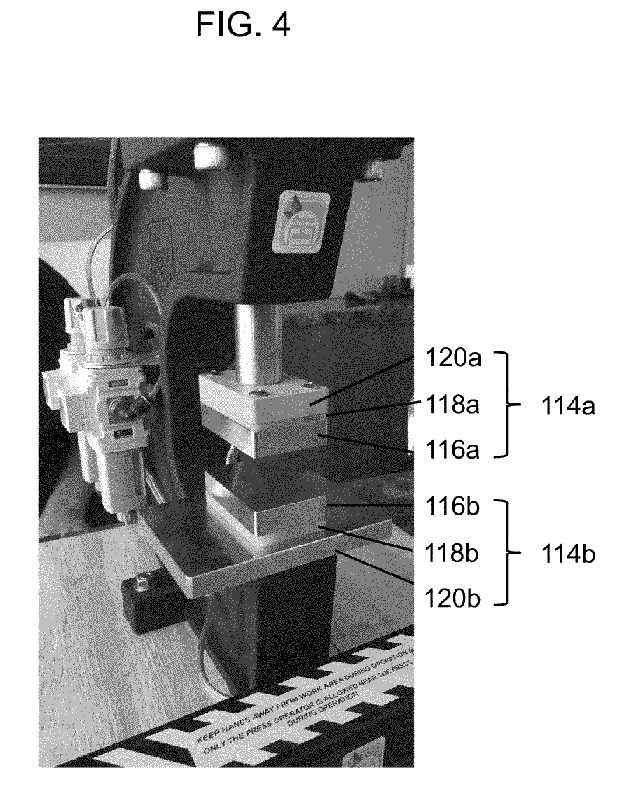

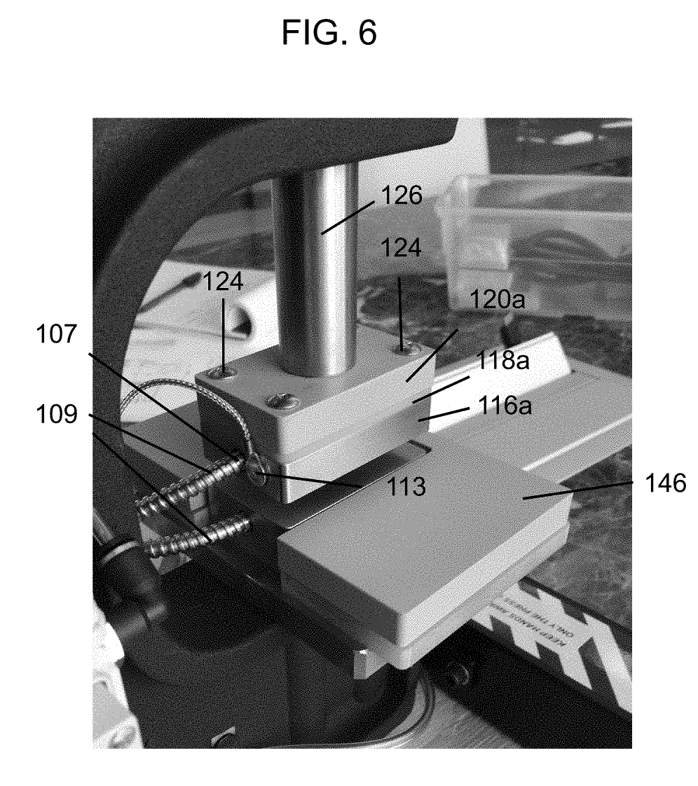

The temperature controller 104 is used to apply and automatically regulate heat to heating elements 112 embedded in the stage 110 (see FIGS. 13B and 15B, and FIGS. 6 and 8 depicting control lines 109 for supplying power to the heating elements 112). The stage 110 includes upper and lower platforms 114a, 114b as shown in FIGS. 3 and 4. The terms “upper” and “lower” are in reference to the location of the sample during use of the extraction unit. During operation, a sample of material is placed in between the upper and lower platforms 114a, 114b of the stage 110, and held during the application of heat and pressure. The upper platform 114a includes an upper heat platen 116a, an isolation mount 118a, and an upper mount or upper mount plate 120a. The lower platform 114b similarly includes a lower heat platen 116b, an isolation mount 118b, and a lower mount or lower mount plate 120b.

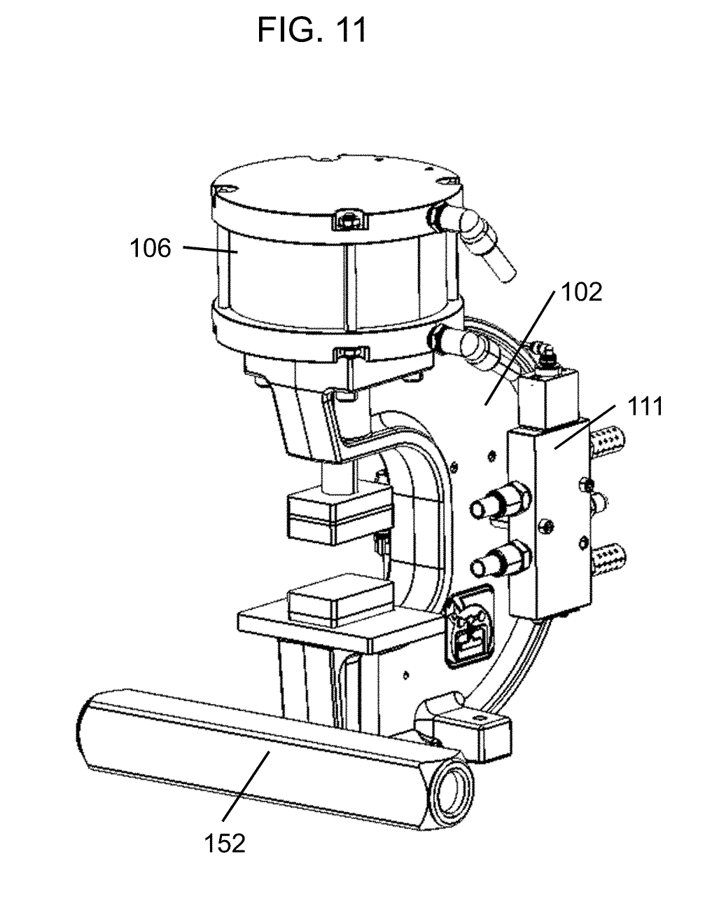

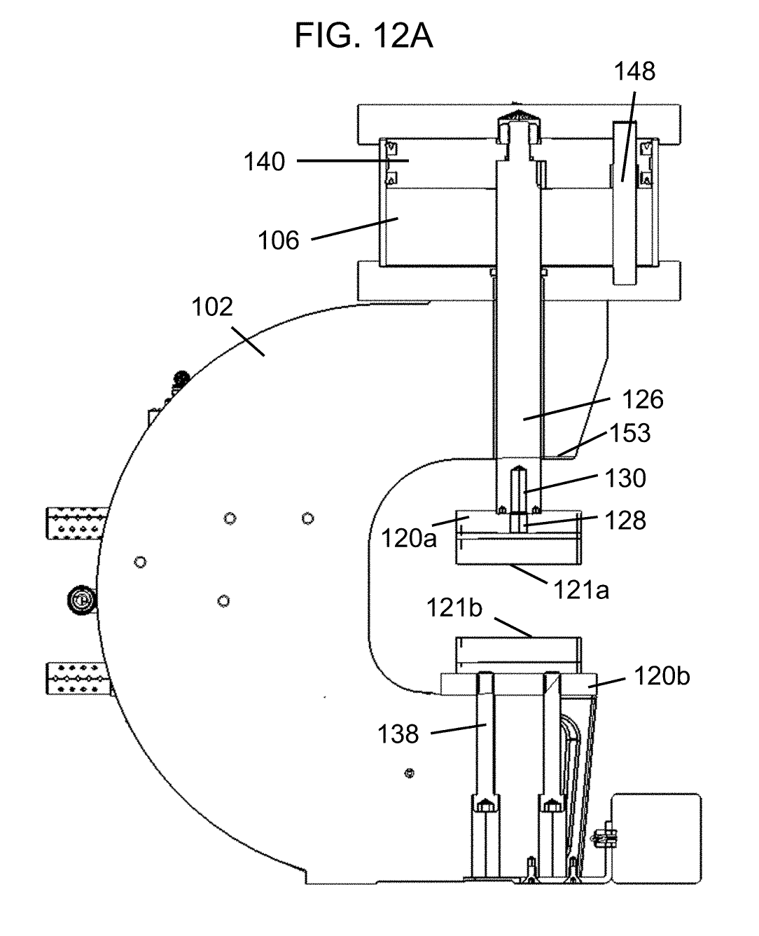

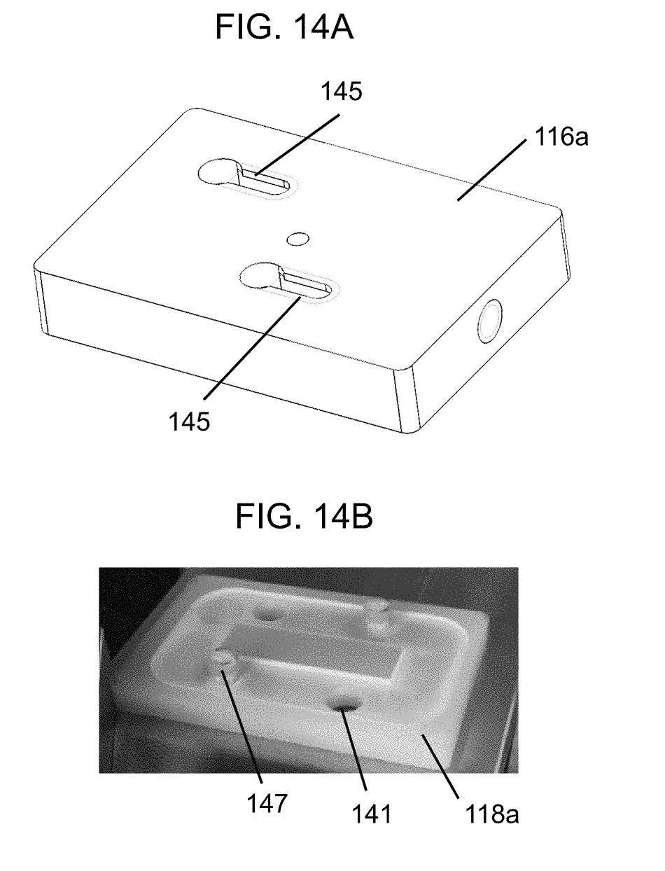

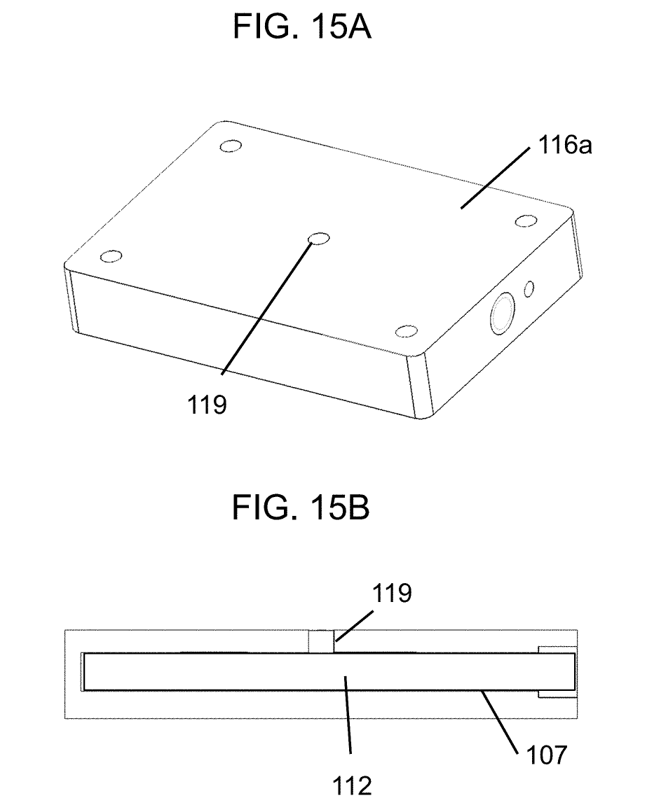

The upper and lower heat platens 116a, 116b include heating elements 112, as shown in FIGS. 13B and 15B. The heating elements 112 are used to conduct and direct heat from the heat platens 116a, 116b to a sample placed between the platens 116a, 116b. In some embodiments, the heating elements 112 may include one or more embedded cartridge heaters that are located inside a cavity or bore 107 in the platens (see FIGS. 6, 8, 13B, and 15B), and may span a length of the respective heat platen. The cartridge heaters may be held in place in the heat platens 116a, 116b by set screws 117. The set screws 117 may connect to the cartridge heaters via an opening or channel 119 (see FIGS. 13A-13B, 15A-15B), which extend from an outer surface of the respective heat platen 116a, 116b to the cavity 107. The opening 119 is sized to permit the set screw 117 to pass therethrough for securing the cartridge heaters in the heat platens 116a, 116b. While the system shown in FIGS. 6 and 8 is depicted as including heating elements 112 in both the upper and lower heat platens 116a, 116b, it should be appreciated that in some embodiments, the heating elements 112 may be included in (or on) one or both of the heat platens. For example, in some embodiments, only the upper platen 116a contains a heating element. In other embodiments, only the lower platen 116b contains a heating element, and in other embodiments both the upper and lower platens contain heating elements. In some embodiments, different types of heating elements may be used, such as ring-shaped heating elements, disc heaters, strip heaters, heat cables, and the like. Further, the heating elements 112 may include elements embedded in the heat platens 116a, 116b, and/or may include surface heating elements applied to exposed surfaces of the platens.

The heating elements 112 are connected to the temperature controller 104, which may use P, PI, and/or PID control algorithms to automatically regulate the temperature of the heating elements 112. During operation, one or more temperature sensors 113 are used to provide feedback to the temperature controller 104 regarding the current temperature of one or more locations of the heat platens 116a, 116b (see FIG. 6). The temperature controller uses measurements from the temperature sensors 113 to adjust the applied power to the heating elements in order to automatically adjust the temperature profile, for example, based on user defined settings. In some embodiments, a user can set the temperature of the heating elements 112 to be maintained at 180° F. for a set period of time, for example approximately 30 seconds, wherein the temperature controller will then automatically adjust the power applied to the heating elements 112 to achieve the set point temperature. As will be appreciated, it is not practical to entirely eliminate temperature fluctuations, but the temperature controller and the other components of the oil extraction unit can limit temperature fluctuations during pressing to about 2° F.

In some embodiments, one or more temperature sensors 113 may be located on an outer back face of the upper and/or lower heat platen (see FIG. 6). By providing a temperature measurement based on the outer back face of the heat platen, as opposed to an internal position in the heat platens, the temperature controller 104 can provide more accurate instantaneous temperature readings of the surfaces of the platens. This can improve oil extraction, which, as explained above, uses a temperature gradient between the heat platens and the surrounding environment to drive the oil away from the heat platens. For example, during operation, a sample is placed between the upper and lower heat platens 116a, 116b. When cartridge heaters are embedded in the heat platens 116a, 116b, heat from the cartridge heaters will propagate via thermal conduction from the cartridges to the platens 116a, 116b and then to the outer surfaces of the respective platens 116a, 116b. The sample will then receive a portion of the heat energy from a lower outer surface 121a of the upper heat platen 116a, and from the upper outer surface 121b of the lower heat platen 116b (see FIG. 12A). In other words, it is the upper and lower outer surfaces 121a, 121b of the respective heat platens 116a, 116b that apply the heat to the sample. As such, it may be desired to control the heater cartridges based on the surface temperatures of the heat platens 116a, 116b. In some embodiments, the temperature sensors 113 may be placed on the outer back face of the upper and/or lower heat platens 116a, 116b, to provide feedback of the surface temperatures of the platens. One of ordinary skill in the art will appreciate that the temperature sensors 113 may be placed away from the upper and lower surfaces 121a, 121b of the heat platens 116a, 116b to avoid obstructing the heat path to the sample, and to avoid possible damage to the temperature sensors when pressure is applied to the upper and lower surfaces 121a, 121b. In other embodiments, however, the temperature sensors 113 may be placed in other locations on a surface or multiple surfaces of the heat platens 116a, 116b, and/or embedded inside of the heat platens 116a, 116b.

The upper and lower heat platens 116a, 116b each include substantially parallel exposed surfaces 121a, 121b that face towards each other to provide a uniform application of pressure and temperature across a flat sample of approximately uniform thickness. In some embodiments, the upper and lower heat platens 116a, 116b may have a substantially rectangular cross sectional shape with rounded or chamfered edges and/or corners. The upper and lower heat platens 116a, 116b may each be a separate monolithic part with a one-piece construction to provide a more even temperature profile to a sample (e.g., as compared to a multi-part construction). While the cross section of the heat platens 116a, 116b is depicted as having a rectangular shape with rounded corners, other cross sectional shapes may be used, such as a circular, oval, or square cross sectional shape. In some embodiments, the parallel surfaces of the upper and lower heat platens have the same cross sectional shape.

In some embodiments, the material of the upper and lower heat platens 116a, 116b may be chosen such that it has a thermal conductivity to promote an efficient temperature profile with respect to sample energy draw, insulation plate contact, and temperature controller programming. The material of the heat platens 116a, 116b can help allow smooth and accurate adjustments at low temperatures (i.e., temperatures between about 130° F. and 230° F.), and prevent unwanted temperature spikes and drops during the transfer of energy from the heat platens to the sample. The material of the platens 116a, 116b can also be a material that resists corrosion from various material samples. In some embodiments, the upper and lower heat platens 116a, 116b, are made of steel, stainless steel (such as 316 stainless steel), brass, or aluminum. In some embodiments, the upper and lower heat platens may be made of the same material, or may be made of different materials.

The isolation mounts 118a, 118b of the upper and lower platforms 114a, 114b are located adjacent the upper and lower platens 116a, 116b. The isolation mounts 118a, 118b may be positioned such that they are adjacent to respective outer surfaces of the upper and lower platens 116a, 116b. For example, the isolation mount 118a of the upper platform 114a may be positioned adjacent an upper surface of the upper platen 116a, where the upper surface is opposite to the lower surface 121a of the upper platen 116a that applies heat to a sample. The isolation mount 118b of the lower platform 114b may be positioned adjacent a lower surface of the lower platen 116b, where the lower surface is opposite to upper surface 121b of the lower platen 116b that applies heat to a sample. When the upper and lower platens 116a, 116b are heated (or cooled), the heat energy conducts through the material of the platens in all directions. A portion of the heat energy is directed towards the sample placed in between the platens. Another portion of the heat energy is directed towards the isolation mounts 118a, 118b, without which such heat could potentially propagate into the rest of the oil extraction unit and cause unwanted thermal effects, such as thermal expansion of various components of the system along with an unwanted heat signature or pattern in the opposing heat platen surface. Such unwanted thermal effects could cause the parallel surfaces of the upper and lower heat platens 116a, 116b to become angled relative to each other (i.e., not parallel) and lead to non-uniform pressure or heating of a sample. In some embodiments, it may be desirable to have a maximum amount of the applied heat energy directed towards the sample and away from the isolation mounts and the rest of the oil extraction unit in a beneficial pattern for the extraction. Accordingly, the isolation mounts 118a, 118b are made of insulating materials having a low thermal conductivity to reduce heat conduction into and through the isolation mounts and to direct a maximum amount of heat towards the sample. In some embodiments, the isolation mounts are made of a rubber or polymer material, such as polyethylene, polypropylene, acrylic, nylon, and the like. Alternatively, the isolation mounts could be made of a fiberglass or glass laminate and epoxy resin, such as a G10 resin. In some embodiments, the isolation mounts 118a, 118b may have the same cross sectional shape as the respective platens 116a, 116b. While the isolation mounts are depicted as having the same cross sectional shape as the heat platens 116a, 116b in FIG. 4, the isolation mounts may have a different shape than the heat platens. For example, the isolation mounts may have a larger or smaller cross section than the heat platens and any suitable shape to prevent unwanted heat from affecting the oil extraction unit components. In some embodiments, the isolation mounts 118a, 118b may each be a separate monolithic part with a one-piece construction.

Adjacent the isolation mounts 118a, 118b are upper and lower mount plates 120a, 120b, as shown in FIGS. 4 and 6. The upper and lower mount plates 120a, 120b are used to locate and mount the isolation mounts 118a, 118b and the heat platens 116a, 116b to the extraction unit 100. As described in more detail below, the upper and lower heat platens 116a, 116b provide a user friendly design enabling a modular assembly by being able to quickly and effectively change the heat platens between different operational runs of the extraction unit 100.

In some embodiments as shown in FIGS. 7-8 and 13A, the lower heat platen 116b is removably attached to the extraction unit 100 by slots 144. The lower heat platen 116b is removably connected to the isolation mount 118b via alignment posts 142 of the isolation mount 118b that mate with slots 144 in the lower heat platen 116b. The lower heat platen 116b uses the alignment posts 142 for aligning and locking the lower heat platen 116b in place. The lower heat platen 116b can be assembled to the extraction unit 100 by hand and without the use of tools, such as a screw driver or a hex wrench. A user can initially locate the lower heat platen by inserting an alignment post 142 of the isolation mount 118b into an enlarged bulbous portion 144a of each of the slots 144 (see FIG. 13A), for example, by lowering the lower heat platen 116b onto the isolation mount 118b. The lower heat platen 116b can then be slid (e.g., horizontally) relative to the isolation mount 118b such that a reduced width portion 144b of slots 144 becomes engaged with the alignment posts 142 and the lower heat platen 116b is locked in place, for example via a press fit, interference fit, or friction fit. In some embodiments, the alignment posts 142 may have a head portion 142a that has a larger width or diameter than a body portion 142b thereof (see FIG. 7), the head portion 142a configured to engage the slot 144 to prevent relative vertical movement between the heat platen 116b and the isolation mount 118b. The head portion 142a may form a free end of the alignment posts 142, with the body portion 142b extending (e.g., perpendicularly) to a main body 142c of the isolation mount 118b. For example, the body portion 142b may be between the head portion 142 and the main body 142c of the isolation mount 118b. The bulbous portions 144a of the slots 144 can have a larger width than the alignment posts 142 to allow for quickly attaching and detaching the lower heat platen 116b to the isolation mount 118b (e.g., by vertical movement of the lower heat platen 116b relative to the isolation mount 118b). The reduced width portions 144b of the slots 144 can have a width or diameter smaller than or approximately equal to the alignment posts 142 to prevent the lower heat platen 116b from being removed from isolation mount 118b when engaged (e.g., via a press fit, an interference fit, or a friction fit). The reduced width portions 144b of the slots 144 may include an undercut 144c sized to engage the head portion 142a of the posts 142, and a stop 144d with a smaller width than the head portion 142 to prevent the heat platen 116b from being removed (e.g., vertically removed). In some embodiments, the reduced width portions 144b of the slots 144 can engage the alignment posts 142 with a press fit, interference fit, or friction fit to prevent inadvertent movement of the lower heat platen 116b relative to the isolation mount 118b after mounting. In some embodiments, one or more stops, blocks, and/or pins can prevent inadvertent movement of the lower heat platen 116b relative to the isolation mount 118b after mounting. For example, after mounting of the lower heat platen 116b onto the isolation mount 118b, an inserted pin can be connected to the lower heat platen 116b and isolation mount 118b to limit or prevent horizontal movement between the lower heat platen 116b and isolation mount 118b.

While two slots 144 and two alignment posts 142 are depicted in FIGS. 7-8, it should be appreciated that a different number of slots 144 and alignment posts 142 can be used (e.g., three slots and three alignment posts). In some embodiments, the posts 142 of the isolation mount 118b are made of a low thermal conductivity material, as described above, to minimize heat transport into the lower mount plate 120b from the lower heat platen 116b. While in the above description the isolation mount 118b contains the slots 144 and the heat platen 116b contains the posts 142 to connect to the slots 144, in some embodiments, the isolation mount 118b may contain the slots and the heat platen 116b may contain the posts.

As shown in FIG. 7, the isolation mount 118b is removably connected to the lower mount plate 120b by fasteners 139. The lower mount plate 120b is in turn removably attached to the frame 102 by fasteners 138 (see FIG. 12A). In some embodiments, the fasteners 138 and 139 are threaded fasteners that are easily removable such as screws or bolts, but it will be appreciated that they could also be non-threaded fasteners such as pins.

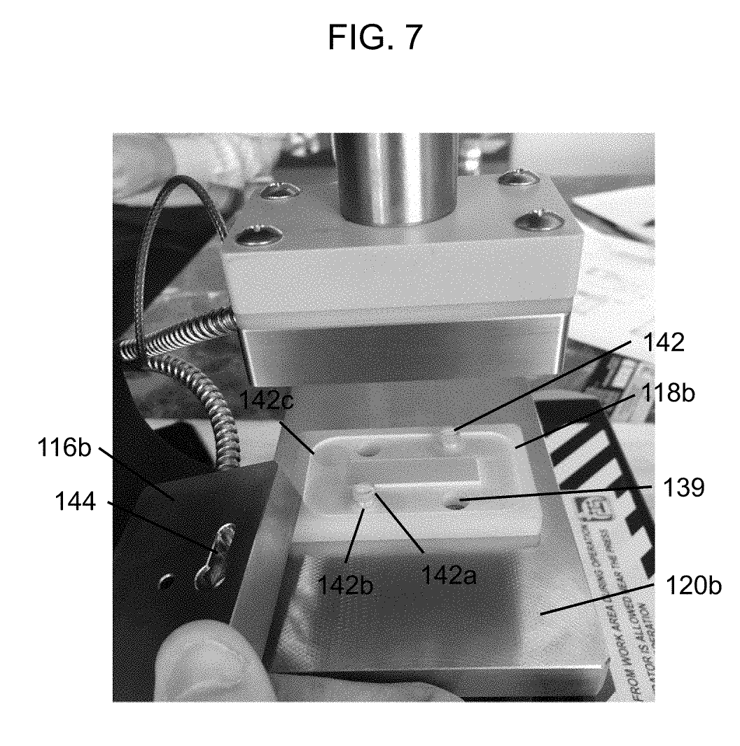

In some embodiments as shown in FIG. 6, the upper heat platen 116a is removably attached to the extraction unit 100 by four fasteners 124. In some embodiments, the fasteners 124 are screws, but they could also be other suitable fasteners that are either removable, such as bolts or pins, or more permanent, such as rivets. The fasteners 124 connect the upper mount plate 120a, isolation mount 118a, and upper heat platen 116a together. The upper mount plate 120a is further connected to a shaft or rod 126 of the actuator 106. In operation, the shaft 126 of the actuator 106 moves in response to pressure applied by the piston 106 to apply pressure to a sample through direct or indirect contact by the upper heat platen 116a. That is, the upper heat platen 116a is movable relative to the lower heat platen 116b. For example, the shaft 126 of the actuator 106 moves downward (e.g., vertically downward) to press the upper heat platen 116a against the sample. The sample is in turn compressed between the upper heat platen 116a and the lower heat platen 116b. In some embodiments, the lower heat platen 116b may be stationary. It should be appreciated that in some embodiments, the lower heat platen 116b may be movable relative to the upper heat platen 116a, and in some embodiments, the upper heat platen 116a may be stationary. In some embodiments, both the upper and lower heat platens 116a, 116b may be movable relative to each other. The shaft 126 of the actuator 106 is connected to the upper mount plate 120a by a fastener 137 that connects a bore 128 of the upper mount plate 120a and an aligned bore 130 of the shaft 126 (see FIGS. 9A-B and 12A-B). One or both of the bores 128, 130 may be threaded to allow for a threaded connection, which permits simple removal and replacement of the upper mount plate 120a. Further, the upper mount plate 120a can include a countersink or counterbore opening 132 to allow a fastener to be recessed relative to the surface of the mount plate 120 (see FIG. 9B). This allows for a tighter fit between the upper mount plate 120a and the isolation mount 118a. In addition, the upper mount plate 120a may include two alignment pins 134 that mate with corresponding bores 136 of the shaft 126 to facilitate proper alignment of the upper mount plate 120a relative to the extraction unit 100, as shown in FIGS. 9A and 12B.

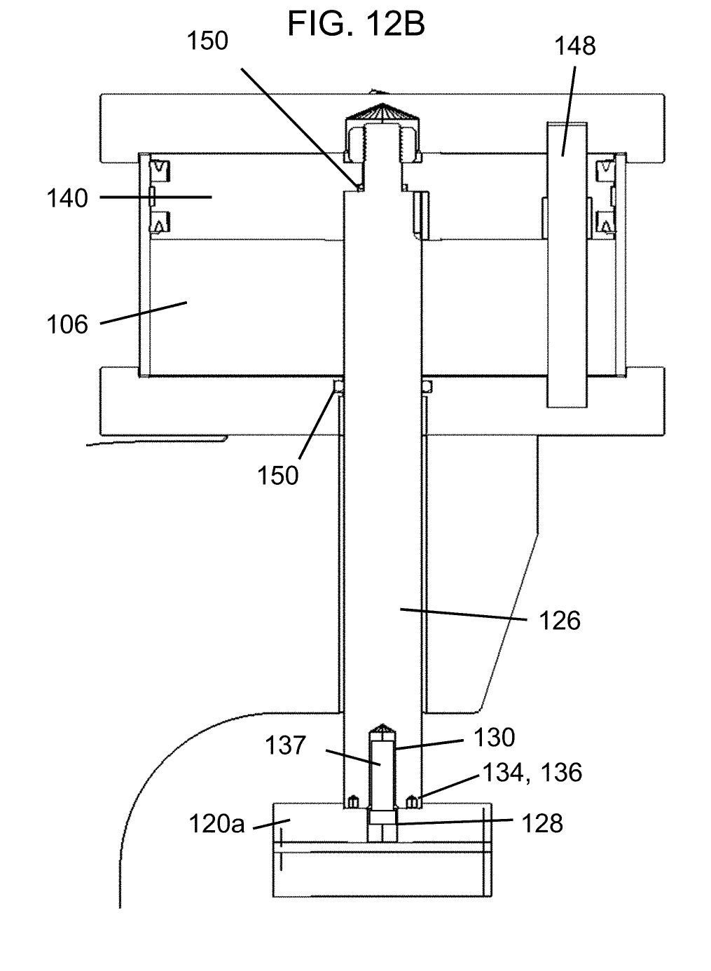

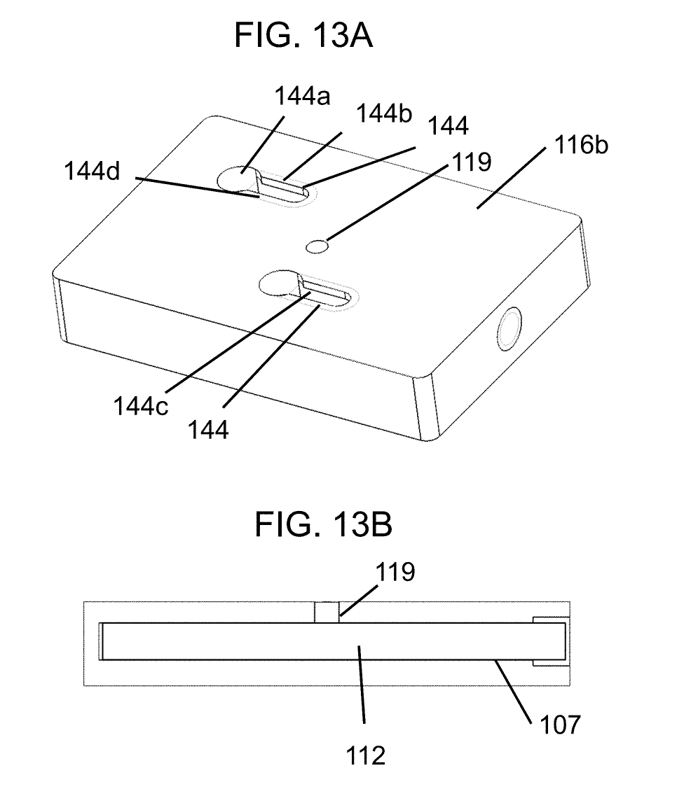

In some embodiments as shown in FIGS. 14A-B, upper heat platen 116a is removably attached to the extraction unit 100 using slots 145 of the upper heat platen 116a and posts 147 of the isolation mount 118a, similar to the lower heat platen 116b described above. In some embodiments, the upper heat platen 116a may include the posts and the isolation mount 118a may include the slots. The upper heat platen 116a of FIG. 14A can be assembled to the extraction unit 100 by hand and without the use of tools (such as a screw driver or a hex wrench) using a similar process as the lower heat platen 116b described above. In some embodiments, the isolation mount 118a of FIG. 14B can have a similar configuration to the isolation mount 118b described above. The isolation mount 118a is removably connected to the upper mount plate 120a by fasteners 141. The upper mount plate 120a is in turn removably attached to the shaft 126 of the actuator 106 as described above.

It should be appreciated that the upper and lower mount plates 120a, 120b can have the same or a different cross sectional shape and/or a different cross sectional area than the heat platens 116a, 116b and/or the isolation mounts 118a, 118b. In the embodiment shown in FIG. 4, the upper mount plate 120a has the same cross sectional shape and the same cross sectional area as the upper heat platen 116a, and the lower mount plate 120b has a larger cross sectional shape and area than the lower heat platen 116b. The larger cross sectional shape of the lower mount plate 120b creates a mounting surface for the application of a cooling plate 146 as shown in FIG. 6 and described more fully below.

The upper and lower heat platens 116a, 116b are configured to be removed from the extraction unit 100 (e.g., removably attached) and to be replaced by other platens having, for example, different sizes or properties, providing a modular design that can be reconfigured between uses and providing a number of benefits. For example, removable platens allow for multiple different sized platens (or platens of different properties) to be used with the extraction unit at different times to accommodate different batch sizes or different sample properties in different runs. By way of example, an operator is able to the use the extraction unit with first, small sized heat platens (e.g., having a cross-sectional shape measuring approximately 1.75 inches by 2.8 inches).

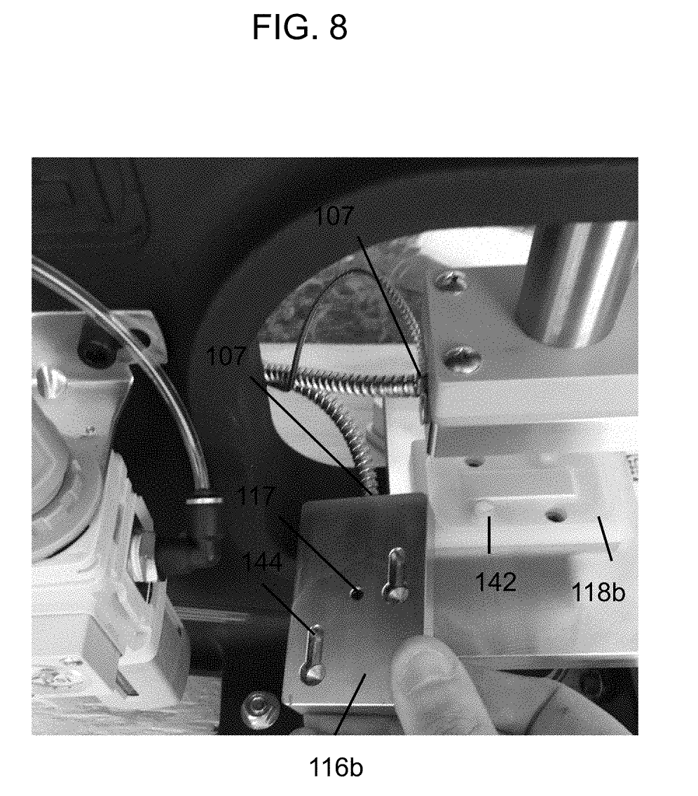

After one or more runs have been completed with the first heat platens, the operator is then able to change the platens to use the extraction unit with second, larger sized heat platens (e.g., having a cross-sectional shape measuring approximately 2.8 inches by 4 inches). For example, FIG. 10 depicts a larger sized lower heat platen 114b′ having two control lines 109′ supplying power to separate heating elements. When changing between different sized platens, an operator may initially operate the extraction unit with smaller sized platens and change to larger sized platens, or vice versa. It should be appreciated that the modularity of the extraction unit allows for platens having many different characteristics to be used interchangeably in the extraction unit, including being of a different size, shape, thickness, and material. As another example, an operator can run the extraction unit 100 with first platens suitable for one sample type and change the platens to run the extraction unit 100 for other sample types. As described above, in some embodiments, the upper and/or lower heat platens 116a, 116b may be attached and removed from the extraction unit by hand without the use of tools, even a screwdriver or wrench. And as further described above, the platens may have different shapes other than a rectangular cross-sectional shape. In addition, an operator may elect to change only one of the platens between runs (e.g., either the upper or the lower platens).

The use of removable platens also provides for easy cleaning and maintenance of the extraction unit 100. An operator can easily clean or decontaminate the platens by removing them and separately cleaning them. This helps to avoid or minimize cross contamination between batches of different samples. For example, a first batch can be run with a sample material on a first set of heat platens, and a second batch can be run with a sample of a different material on a second set of heat platens. Moreover, the removable platens allow for easier maintenance and repair of the extraction unit, for example, if the platens or their heating elements become damaged. This also improves operational efficiency of the extraction unit by increasing the amount of use time of the device relative to an extraction unit having non-removable platens. For example, new platens can be installed to allow continued operation of the extraction unit, rather than having the machine sit in a non-operational state due to required maintenance.

In some embodiments, the upper and lower heat platens 116a, 116b may be removed from the extraction unit 100 as follows. The upper heat platen 116a can be removed from the upper mount plate 120a by removing the fasteners 124. In doing so, the upper mount plate 120a will remain attached to the shaft 126 of the actuator 106 because the upper mount plate 120a is connected to the shaft 126 by a separate connection. The lower heat platen 116b can be removed from the isolation mount 118b by sliding the slots 144 of the lower heat platen 116 relative to the alignment posts 142 of the isolation mount 118b and lifting the lower heat platen 116 off of the isolation mount 118b when the bulbous portions 144a are aligned with the alignment posts 142. When removing the lower heat platen 116b, the isolation mount 118b will remain connected to the lower mount plate 120b. Once the upper and lower heat platens 116a, 116b are removed, the heating elements 112 can be removed from the upper and lower heat platens 116a, 116b, for example, by removing a set screw connection. In addition, the control lines 109 connecting the heating elements 112 to the temperature controller 104 may also be removed.

In some embodiments, the upper and lower heat platens 116a, 116b may be removed from the extraction unit 100 as follows. The upper heat platen 116a may be removed from the isolation mount 118a by sliding the slots 145 relative to the alignment posts 141 and lowering the upper heat platen 116 off of the isolation mount 118a. The lower heat platen 116a may be removed from the isolation mount 118b by sliding the slots 144 relative to the alignment posts 142 and lifting the lower heat platen 116 off of the isolation mount 118b. Using this procedure, both the upper and lower heat platens 116a, 116b may be removed from the extraction unit by hand without the use of tools. When removing the upper and lower heat platens 116a, 116b, the isolation mounts 118a, 118b will remain connected to the upper and lower mount plates 120a, 120b, respectively. Once the upper and lower heat platens 116a, 116b are removed, the heating elements 112 can be removed from the upper and lower heat platens 116a, 116b, for example, by removing a set screw connection. In addition, the control lines 109 connecting the heating elements 112 to the temperature controller 104 may also be removed.

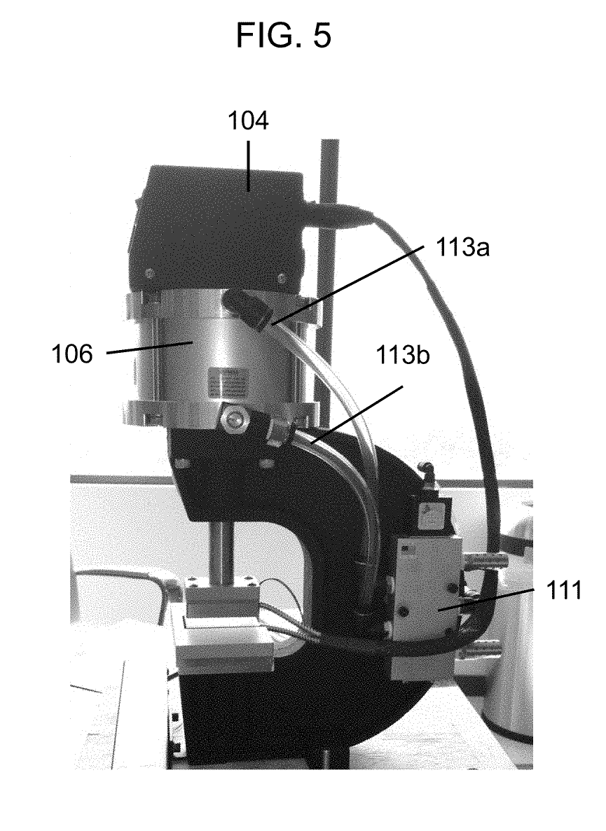

As described above, the actuator 106 is used to supply pressure to a sample via the upper heat platen 116a. In some embodiments, the actuator 106 may be a pneumatic air cylinder containing a piston 140 (see FIGS. 12A-B). In such embodiments, compressed air (e.g., from a compressed air hose or from an air compressor) is supplied to one or more air regulators 108. The air regulators 108 are used to condition the air to preset air pressure limits. In some embodiments, the compressed air may be regulated to between 80-125 pounds per square inch (PSI). Within this larger range, however, it will be appreciated that a user can set a desired input or line pressure, for example, at 80 PSI or 100 PSI. The pneumatic air cylinder uses a power factor that multiplies the input pressure to a larger force that is applied to a sample. For example, for a pneumatic air cylinder having a five inch piston, the piston power factor may be approximately 19.625, and the pneumatic air cylinder can output approximately 2355 pounds of force at 120 PSI line pressure. For a 4 gram sample having a 2 square inch surface area (e.g., 1″×2″), approximately 1177 PSI would be applied to the sample between the platens. As another example, for a pneumatic air cylinder having a six inch piston, the pneumatic air cylinder can output approximately 2800 pounds of force at 100 PSI line pressure. It will be appreciated that a user can set a desired pressure to be applied to the sample, for example, 1175 PSI, and the extraction unit can automatically maintain such pressure within about 1 PSI. Accordingly, the extraction unit may apply a substantially constant pressure to a sample over the duration of the pressing process. In some embodiments, air from the air regulator 108 is sent to the directional control valve 111, which distributes the compressed air to the pneumatic air cylinder. As shown in FIGS. 5, the control valve 111 contains two outlet compressed air lines 113a, 113b that are input into the pneumatic air cylinder. The first air line 113a supplies compressed air to a region above the piston 140. When the air line 113a is activated, the air pressure applied above the piston causes the piston to move down and apply pressure to a sample. The second air line 113b supplies compressed air to a region below the piston. When the air line 113b is activated and air line 113a is deactivated, the air pressure applied below the piston causes the piston to move up and release pressure applied to a sample. In some embodiments, pressure on a sample can be released by turning off air pressure to both air lines 113a, 113b. In some embodiments, the actuator 106 may be a pneumatic or hydraulic pressure device that uses a different working fluid or gas than air.

In some embodiments, pressure may be applied in stages, such as an initial lower applied pressure followed by an increased applied pressure. An adjustment feedback loop may be used with the actuator 106 via a positioning sensor to determine when a sample has reached a desired or predetermined thickness.

In some embodiments, the pneumatic air cylinder may contain a single six inch piston having a nominal output of 2800 pounds of force at 100 PSI line pressure. Other diameter piston sizes may be used, such as a five inch piston.

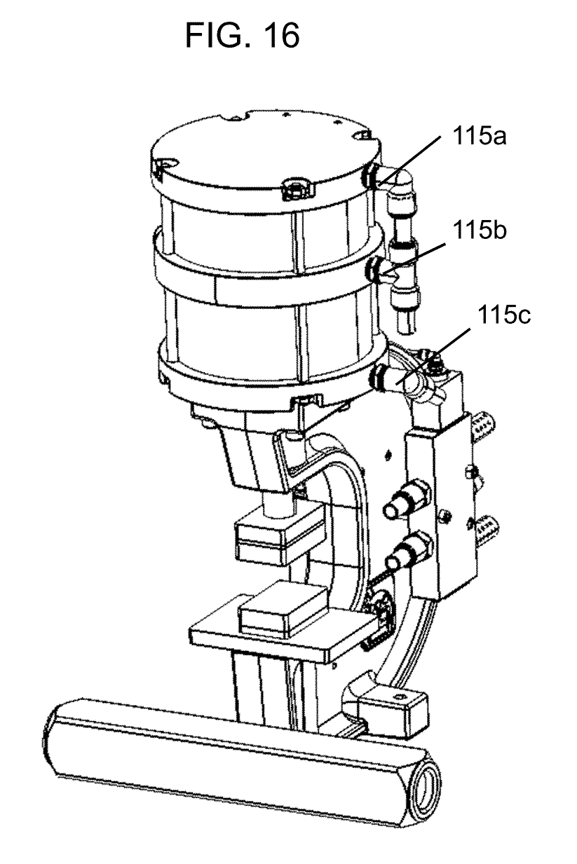

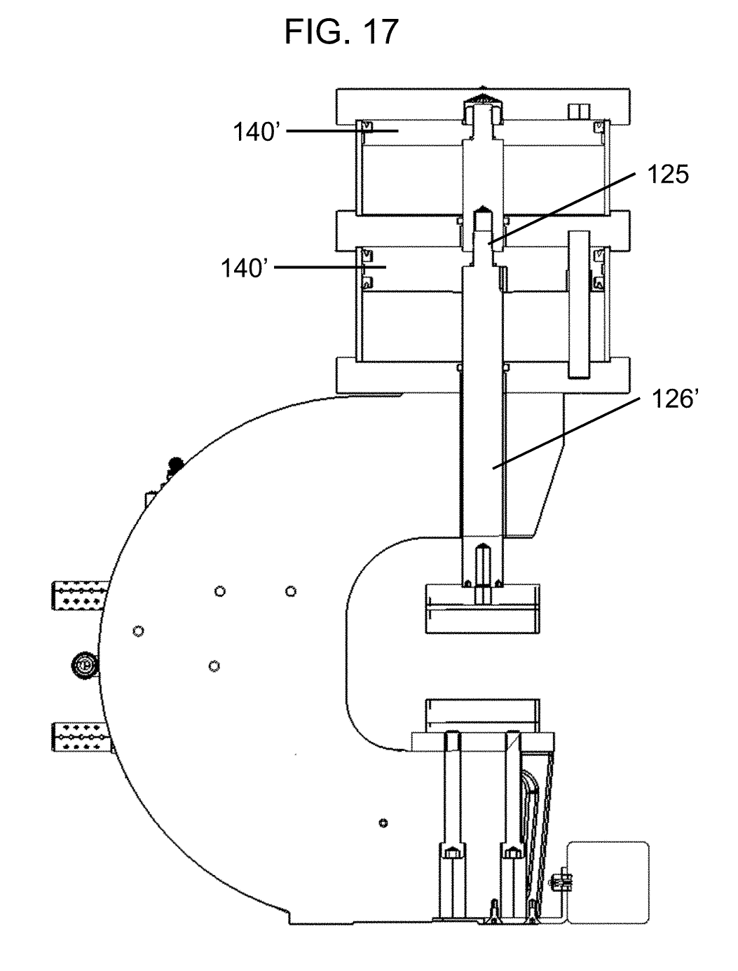

In some embodiments, it may be desired to be able to supply additional pressure, for example, for larger sample sizes. In such embodiments, the pneumatic air cylinder may contain two stacked pistons 140′ as shown in FIGS. 16-17. The pistons are joined together via a common shaft 126′, which has a threaded connection 125 that joins two shaft segments together. In such embodiments, each piston has a separate input 115a, 115b that allows compressed air (or another working fluid or gas) to apply pressure to a region above its respective piston (see FIG. 16). When pressure is simultaneously applied to the regions above each piston, the amount of force is multiplied relative to a single piston design. To release the applied pressure, compressed air (or another working fluid or gas) can be applied to an input 115c below the bottom piston (see FIG. 16). Release of applied pressure may also be achieved by releasing pressure to inputs 115a, 115b, and 115c. In some embodiments, the pneumatic air cylinder may contain two stacked six inch pistons having a nominal output of 5600 pounds of force at 100 PSI line pressure. Each stacked piston may have a six inch diameter, but other diameters are contemplated. Further, more than two stacked pistons may be applied.

To prevent rotation of the pneumatic air cylinder and the shaft 126 during use, an anti-rotation rod 148 can be keyed into the piston and upper and lower portions of the cylinder, as shown in FIGS. 12A-B. The rod 148 prevents rotation of the piston 140 while permitting translation of the piston for applying pressure. The shaft 126 can be rigidly affixed to the piston such that the shaft 126 cannot rotate relative to the piston.

As described above, the upper heat platen 116a is connected to the shaft of the actuator or pneumatic air cylinder via the upper mount plate 120a. When heat is applied to the upper heat platen 116a, a portion of the heat energy may propagate into the pneumatic air cylinder when operating the extraction unit for extended periods of time. To reduce wear of components, the pneumatic air cylinder can use high temperature seals 150, as shown in FIG. 12B. Such high temperature seals may be made of a high temperature rubber or elastomer, such as Viton.

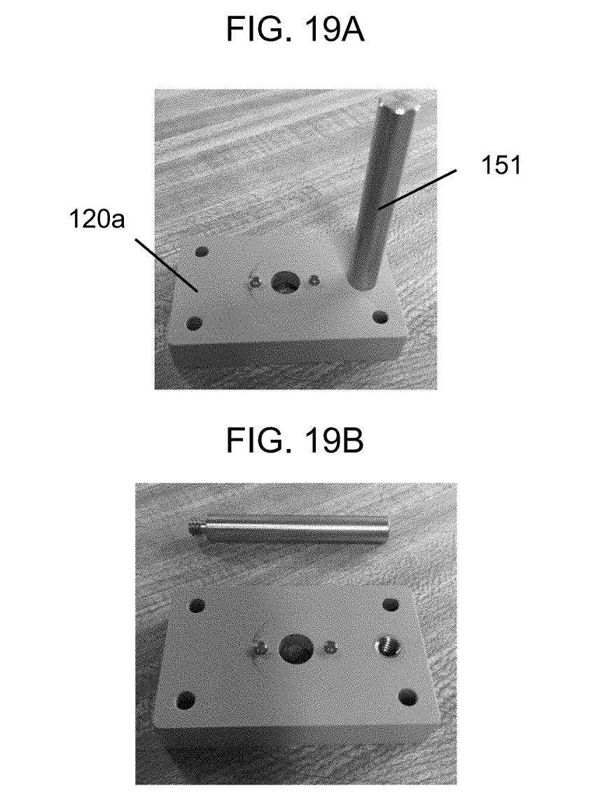

In some embodiments, it may be desirable to limit the amount of travel of the shaft 126 of the actuator 106 in order to minimize processing time per sample, such as by limiting the amount of upstroke of the shaft 126 in order to limit a maximum spacing between the upper and lower heat platens 116a, 116b. In some embodiments, an external sleeve or standoff may be placed around the shaft that fits between an upper surface of the upper mount plate 120a and a lower surface 106a of the actuator 106 to limit the maximum spacing between the heat platens 116a, 116b. In other embodiments, an internal stop may be placed inside the actuator 106 to limit the travel of the shaft 126 and the maximum spacing between the heat platens 116a, 116b. In some embodiments, the upper mount plate 120a can include a standoff 151 (see FIGS. 19A-19B) to limit the amount of travel of the shaft 126 and the maximum spacing between the heat platens 116a, 116b. The standoff 151 can be positioned between an upper surface of the upper mount plate 120a and a corresponding surface 153 of the frame 102 (see FIG. 12A) to act as a mechanical stop. When the standoff 151 contacts the surface 153 of the frame 102, the upper platform 114a and shaft 126 are prevented from further movement upwards, such that upstroke of the shaft 126 is limited. The standoff 151 may be threadably connected to the upper mount plate 120a.

In some embodiments, the actuator 106 may be a manually operated actuator that applies pressure using a hand lever or foot pedal.

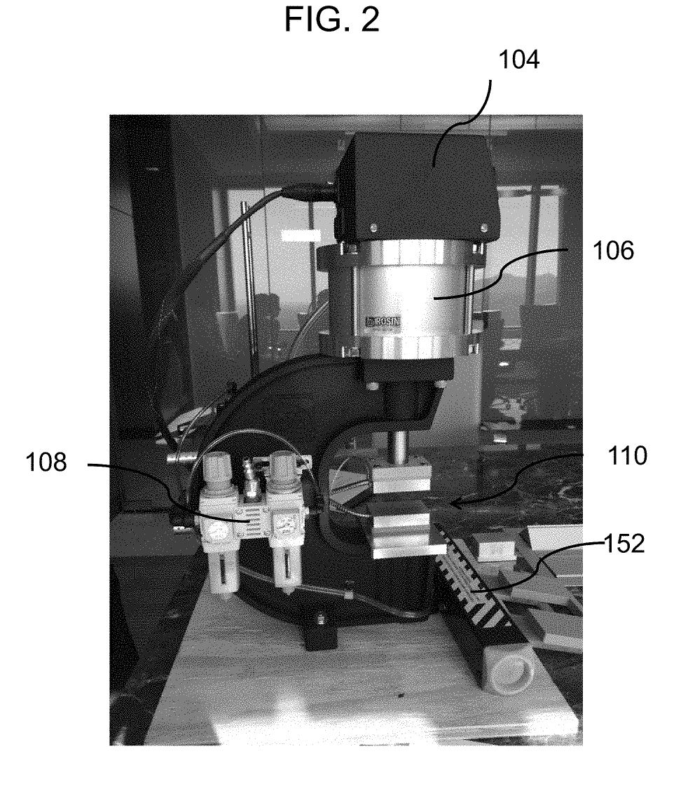

In some embodiments, a safety control 152 may be applied, as shown in FIGS. 1 and 2. The safety control 152 includes an air line that is attached to a regulator 108. The safety control 152 also includes another air line that is connected to the directional control valve 111. The safety control 152 prevents the directional control valve 111 from operating (i.e., allowing compressed air to flow into the actuator 106), unless the safety control 152 is activated. That is, when the safety control 152 is deactivated, the control valve 111 is in a closed position preventing compressed air from the air regulators 108 from entering the actuator 106. When the safety control 152 is activated, the control valve 111 moves into an open position that allows compressed air to flow. To activate the safety control 152, an operator presses two buttons 152a, 152b, one on each side of the safety control 152. In some embodiments, the safety control 152 supplies compressed air at 80 PSI to open the directional control valve. As shown in FIG. 3, two air regulators 108 are shown. A first air regulator 108a is used to operate the safety control 152 for opening and closing the control valve 111. A second air regulator 108b is used as the compressed air supply for the piston.

Use of the extraction unit 100 according to some embodiments will now be described. First, a sample is prepared. In some embodiments, it has been found that a uniform sample of approximately even thickness used in the extraction unit 100 allows for uniform pressure to be applied to the entire cross section of the sample, which thereby results in a sufficient yield of product at a desirable quality. However, it will be appreciated that a variety of sample sizes and shapes may be used, including regular or irregular shapes.

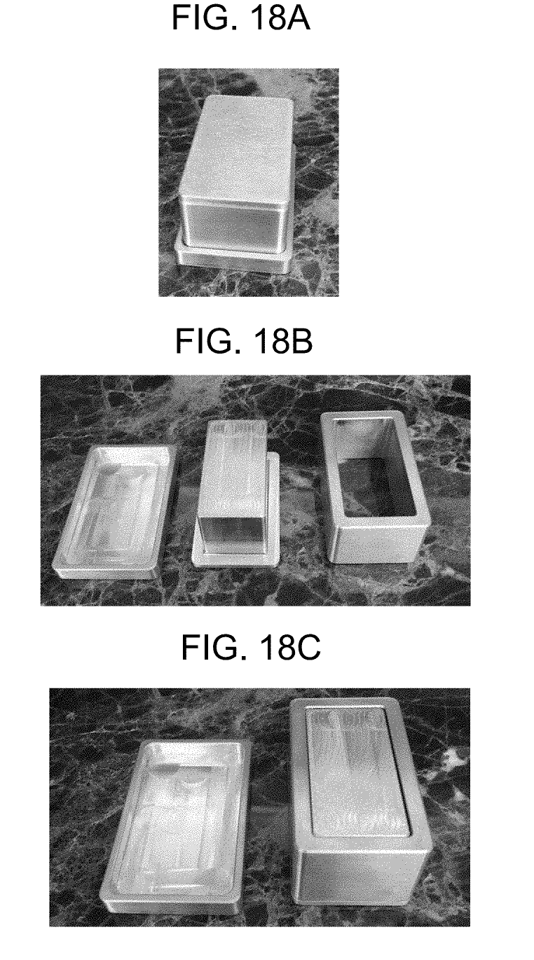

To create a uniform sample of approximately even thickness, a mold may be used as shown in FIGS. 18-C to pre-process the samples. A sample is placed inside of the mold and squeezed under light pressure. The pressure causes the sample to spread out in the mold, creating a thin sample of approximately uniform thickness, also known as a “puck.” In some embodiments, the mold is capable of pressing 2-6 grams of a sample. In some embodiments, the mold is capable of pressing 6-14 grams of a sample. In some embodiments, the pre-processed sample will have a thickness of approximately 0.15 or 0.25 inches. The mold may be made of aluminum, steel, or stainless steel and may have a cross sectional size of approximately 1 inch by 2 inches, but other sizes may be used. The puck is then placed inside a porous filter bag for processing in the extraction unit 100. The filter bag may act as a 25 to 90 micron filter. The use of the filter bag helps to separate out the extracted oils from the residue of the sample.

After the sample has been prepared inside the filter bag, the prepared sample is placed between the upper and lower heat platens 116a, 116b. Smaller batch sizes (e.g., 2-6 grams or 6-14 grams of material) are advantageous for use with the extraction unit 100 because non-uniform heating may occur with larger batch sizes. That is, in a larger batch size, the edges of the batch will be drawn out more quickly from the sample. The center of a large batch, however, will take longer to propagate out of the sample and thus will spend more time under heat and pressure. This will make it more likely that the center of the batch undergoes a phase transformation due to the longer application of heat and pressure, which can reduce the quality of the oil that is produced. The overheated material mixes with the material that was easily extracted. A larger batch size, and in particular a batch that does not utilize active cooling, can thus result in oil that has poor quality and/or a lower yield than a smaller batch size.

Layers of parchment paper may be used and placed around the sample to minimize contaminating the heat platens. Pressure and temperature are applied to the sample to extract the oil. Pressure is applied via the actuator 106 as described above. Heat is applied via the heating elements 112 as described above. For example, as pressure is applied, the shaft 126 of the actuator 106 moves downward (e.g., vertically downward) to press the upper heat platen 116a against the sample. The sample is in turn compressed between the upper heat platen 116a and the lower heat platen 116b. During use, extracted oils will seep out from the filter bag and onto the parchment paper for collection. The extracted oils will be drawn away from the higher temperature heating elements 112 and towards an area outside of the heat platens.

One or more cooling plates 146 (see FIG. 6) may be applied outside of the heat platens to further draw out the extracted oils away from the heat platens and limit exposure of the oils to elevated temperatures. The cooling plates 146 may have a size that is complementary to the upper and/or lower heat platens 116a, 116b. In use, the cooling plates 146 may surround a portion or the entire circumference or perimeter of the upper and/or lower heat platens 116a, 116b to provide active cooling that further draws extracted oils towards areas outside of the heat platens. The cooling plates 146 provide a further temperature gradient relative to the elevated temperature of the heating elements 112 and the heat platens. The cooling plates 146 may be applied to either or both of the upper and lower heat platens 116a, 116b. The cooling plates 146 may be chilled prior to use with the extraction unit 100. In some embodiments during use of the extraction unit 100, heat will be conducted from the upper and/or lower heat platens 116a, 116b thereby raising the temperature of the cooling plates 146 and decreasing the temperature gradient between the heat platens and the cooling plates, which may decrease the effectiveness of the cooling plates over time or over different operational runs. In some embodiments, the cooling plates 146 can be replaced during different operational runs. In some embodiments, the cooling plates 146 may include features to remove heat from the cooling plates 146 during use of the extraction unit 100 to maintain a temperature gradient between the cooling plates and the heat platens. Such features may include heat exchangers such as fins and fans on external surfaces of the cooling plates, as well as circulating fluid flow systems.

In some embodiments, pressure and temperature can be electronically controlled, rather than manually, to more precisely and accurately regulate temperature and pressure applied to a sample. In some embodiments, the heat applied via the heating elements 112 may be in the form of a variable temperature profile that is electronically controlled and include more than one temperature set point. The temperature profile may be varied by changing the amount of power applied to the heating elements 112. In some embodiments, the temperature controller may apply an oscillating temperature profile, for example, between 11 to 20 percent of the maximum wattage of the heating elements 112. In some embodiments, the temperature ranges for various samples may be in the range of 135° F. to 230° F. In some embodiments, the temperature and pressure may be applied for between 4 to 90 seconds. Samples are temperature sensitive as longer exposure times and higher temperatures may degrade the quality of extracted oils. In some embodiments, higher temperatures in the range of 220° F. to 230° F. may cause sample and oil degradation in less than 30 seconds. Exposure to elevated temperatures of temperatures of 180° F. or lower may have a less drastic effect on sample and oil quality, and thus samples may be exposed to temperatures ranges of 180° F. or lower for longer periods of time. In some embodiments, a sample may be pressed at 180° F. for approximately 30 seconds, and in other embodiments a different sample may be pressed at 230° F. for 4 secs or 150° F. for up to 90 seconds.

In some embodiments, samples may be placed under additional forces to further extract and draw oils away from the sample. For example, gravity may be used to pull the oil in preferential directions. In addition, static charges may be applied to facilitate faster drawing away from the sample material. For example, static or dynamic applied electric charge (e.g., via an applied voltage or current source) may be applied to the cooling plates to help facilitate oil draw away from the heat platens for collection. When the oil reaches a viscosity that allows for transport, the oil is pulled towards the direction of the applied electric charge. Electric charge may thus be used to limit exposure time of a sample to elevated temperature.

Using embodiments of the extraction unit results in a high yield of high quality oil from a sample. Particularly, an amount of about 4 grams (30%) of oil can be obtained from a 4 gram sample of raw flower material, depending on the raw material. As another example, a 4 gram sample of dry sift concentrate material can yield approximately 90% oil.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. An oil extraction unit for extracting plant oils from a sample, the oil extraction unit comprising:
a stage for accommodating the sample, the stage comprising:
a first platen and a second platen having facing surfaces for accommodating the sample therebetween, wherein the first platen or second platen is movable relative to the other for applying pressure to the sample, and wherein the first platen comprises a heater for applying heat to the sample; and
an isolation mount adjacent the first platen such that the first platen is between the isolation mount and the accommodated sample, wherein the first platen is removably attached to the isolation mount such that the first platen can be removed from the stage by hand and without the use of tools, and
an actuator coupled to either the first platen or the second platen for applying pressure to the sample.

2. The oil extraction unit of claim 1, wherein one of the isolation mount and the first platen comprises an alignment post and the other of the isolation mount and the first platen comprises a slot configured to attach to the alignment post via an interference fit.

3. The oil extraction unit of claim 2, wherein the alignment post comprises a head portion and a body portion, the head portion having a larger width than the body portion and configured to be accommodated by an enlarged bulbous portion of the slot and connected to the slot to prevent relative vertical movement between the first platen and the isolation mount.

4. The oil extraction unit of claim 3, wherein alignment post is configured to be vertically accommodated in the enlarged bulbous portion of the slot, and the first platen is configured to be horizontally slid relative to the isolation mount, such that the head portion of the alignment post is positioned in an undercut portion of the slot to prevent relative vertical movement between the first platen and the isolation mount.

5. The oil extraction unit of claim 4, further comprising two alignment posts and two slots for mounting the isolation mount to the first platen by hand.

6. The oil extraction unit of claim 1, further comprising a second isolation mount adjacent the second platen such that the second platen is between the second isolation mount and the accommodated sample, wherein the second platen is removably attached to the second isolation mount such that the second platen can be removed from the stage by hand and without the use of tools.

7. The oil extraction unit of claim 6, wherein the heater is a cartridge heater position inside of a cavity in the first platen.

8. The oil extraction unit of claim 7, wherein the second platen comprises a heater for applying heat to the sample, the heater positioned inside of a cavity in the second platen.

9. The oil extraction unit of claim 6, further comprising a cooling plate, the cooling plate having an opening sized to surround at least a portion of a perimeter of the first platen.

10. The oil extraction unit of claim 6, further comprising a temperature sensor positioned on an exterior surface of the first platen, the exterior surface positioned away from the facing surfaces of the first plate and the second plate that accommodate the sample, and a temperature controller for controlling a temperature of the heater.

11. The oil extraction unit of claim 1, wherein the second platen is connected to the stage via a mount plate, the mount plate attached to the actuator via a shaft, and wherein the mount plate is connected to a standoff configured to limit an amount of travel of the first and second platens relative to each other.

12. An oil extraction kit for extracting plant oils from a sample, the oil extraction kit comprising:
an oil extraction unit having a stage for accommodating the sample, the stage comprising an upper platform and a lower platform, each platform having a mount for attaching a platen to the respective platform; and
a first set of heat platens comprising a first platen and a second platen configured to be removably attached, respectively, to the upper platform and to the lower platform, wherein when the first and second platens are attached to the stage, opposing surfaces of the first platen and the second platen face each other for accommodating the sample therebetween, wherein the first platen or second platen is movable relative to the other for applying pressure to the sample, and wherein the first platen comprises a heater for applying heat to the sample; and
a second set of heat platens comprising a third platen and a fourth platen configured to be removably attached respectively, to the upper platform and to the lower platform, wherein when the third and fourth platens are attached to the stage, opposing surfaces of the third platen and the fourth platen face each other for accommodating the sample therebetween, wherein the third platen or fourth platen is movable relative to the other for applying pressure to the sample, and wherein the third platen comprises a heater for applying heat to the sample; and
an actuator coupled to either the upper platform or the lower platform for applying pressure to the sample.

13. The oil extraction kit of claim 12, wherein at least one of the opposing surfaces of the first platen or second platen has a different cross-sectional area than at least one of the opposing surfaces of the third platen or fourth platen.

14. The oil extraction kit of claim 13, wherein the opposing surfaces of the first platen and the second platen have a first cross-sectional shape, and the opposing surfaces of the third platen and the fourth platen have a second cross sectional shape, and where the first cross-sectional shape is different from the second cross sectional shape.

15. The oil extraction kit of claim 12, wherein the mount of the lower platform comprises an isolation mount, and wherein the second platen is removably attachable to the isolation mount such that the second platen can be removed from the stage by hand and without the use of tools.

16. The oil extraction kit of claim 15, wherein one of the isolation mount and the second platen comprises an alignment post and the other of the isolation mount and the second platen comprises a slot configured to accommodate the alignment post for mounting the isolation mount to the second platen by hand.

17. The oil extraction kit of claim 16, wherein the alignment post comprises a head portion and a body portion, the head portion having a larger width than the body portion and configured to be accommodated by an enlarged bulbous portion of the slot and connected to the slot to prevent relative vertical movement between the second platen and the isolation mount.

18. The oil extraction kit of claim 17, wherein alignment post is configured to be vertically accommodated in the enlarged bulbous portion of the slot, and the second platen is configured to be horizontally slid relative to the isolation mount, such that the head portion of the alignment post is positioned in an undercut portion of the slot to prevent relative vertical movement between the first platen and the isolation mount.

19. The oil extraction kit of claim 18, further comprising two alignment posts and two slots for mounting the isolation mount to the first platen by hand.

20. The oil extraction kit of claim 12, further comprising a mold for pre-processing a sample to an approximate uniform thickness.
